(19) United States
(12) Patent Application Publication
(10) Pub. No.: US 2017/0207502 A1
(43) Pub. Date: Jul. 20, 2017

(54) ENERGY STORE

(71) Applicant: Pendix GmbH, Zwickau (DE)

(72) Inventor: Sebastian FETHKE, Zwickau (DE)

(73) Assignee: Pendix GmbH, Zwickau (DE)

(21) Appl. No.: 15/327,673

(22) PCT Filed: Jul. 23, 2015
(86) PCT No.: PCT/EP2015/066892

§ 371 Date: Jan. 20, 2017

(30) Foreign Application Priority Data
Jul. 24, 2014 (DE) 10 2014 110 428.5

(51) Int. Cl. H01M 10/48; H01M 10/42; H01M 2/10

(52) U.S. Cl. CPC H01M 10/488; H01M 10/486; H01M 2/1083; H01M 10/425; H01M 2220/20; H01M 2010/4271

(57) ABSTRACT

The invention relates to a smart energy store for mobile consumers. The area of application of the invention is electrically driven vehicles, for example bicycles with an auxiliary electric drive. The invention is based on the object of improving an energy store, which is designed to be removable, for mobile consumers in relation to operability and efficiency. The object is achieved by means of an energy store which has a cell unit with connected battery management system, an indicator device connected to the battery management system, contact means, connected to the battery management system, for connecting to contact means of the mobile consumer at least in the form of high-power contacts and an input device connected to the battery management system. (FIG. 1)

The invention relates to a smart energy store for mobile consumers. The area of application of the invention is electrically driven vehicles, for example bicycles with an auxiliary electric drive. A preferred area of application is bicycles with an auxiliary electric drive, so-called pedelecs.

Electric vehicle drives require an energy source in the form of a battery. From an economical and ecological viewpoint, only rechargeable embodiments are considered here, which are either permanently installed in the vehicle or designed to be removable. The respectively more expedient variant depends above all on the type of vehicle and the required charging capacity. One advantage of energy stores which are designed to be removable consists in that by simply exchanging a discharged energy store for a charged energy store, lower charging capacities and hence shorter charging times and lower weights are possible, with the result that the energy store as weight to be moved requires a lower proportion of the power of the drive. In the case of bicycles with supporting electric drive, for example, this also advantageously operates in the pedal-powered mode since lower weight to be moved is equivalent to lighter tread.

The invention is based on the object of improving an energy store, which is designed to be removable, for mobile consumers in relation to operability and efficiency.

The object is achieved by means of an energy store according to Claim 1, which comprises a cell unit with connected battery management system, an indicator device connected to the battery management system, contact means, connected to the battery management system, for connecting to the mobile consumer and for charging the cell unit at least in the form of high-power contacts and an input device connected to the battery management system. The cell unit with battery management system, indicator device, input device and contact means are arranged in a housing, which is provided with fastening means for fastening to a mobile device having the consumer. The fastening occurs by means of a plurality of bayonet connections, which are arranged asymmetrically in a housing base, that is to say are arranged on a pitch circle diameter with asymmetrical angular position or at least two pitch circle diameters even with symmetrical angular position, from which both convenient one-handed removal and correct contact result.

Advantageous developments and configurations of the invention emerge from the dependent claims. The energy store according to the invention is developed in that the indicator device, the input device and the battery management system are connected to a serial bus system. The access management of the bus system preferably takes place by synchronization and identification of the messages to be transmitted, by virtue of each unit having a controller circuit by means of which it is attached to the bus system. A preferred embodiment of the bus system is, for example, the CAN bus according to ISO 11898. The invention is advantageously configured by the input device being designed as a selector switch. In this case, the selector switch may be configured as an on/off switch and/or for continuous or discrete setting of an electrical parameter, for instance the battery current to set the power of the mobile consumer by virtue of corresponding messages being transmitted, via a communication connection using the bus system, to the battery management system, the indicator device and a suitable receiving device of the mobile consumer. Another advantageous configuration of the invention consists in that the indicator device is designed as illumination means. A preferred design of the indicator device is in this case given in the form of a luminous ring which is connected to one or more light sources. Thus, when a plurality of light sources are used or a light source which generates different frequencies, for example different values of an electrical parameter, for example the state of charge of the cell unit or different electrical parameters such as the critical state of charge of the cell unit and preselected power stages, can be symbolically indicated. Another advantageous configuration of the energy store according to the invention consists in that the contact means comprise shorter pilot contacts in comparison with the high-power contacts, which pilot contacts are connected to the battery management system of the cell unit. As the pilot contacts thus disconnect earlier than the high-power contacts in the event of removal of the energy store from the mobile device, said pilot contacts are switched so as to be voltage-free by the battery management system, as a result of which a switching arc with contact burning at the high-power contacts is avoided.

An exemplary embodiment of an energy store according to the invention is described below with reference to the drawing. The illustrated energy store supplies a mobile consumer in the form of a traction drive of a mobile device with energy. In the drawing:

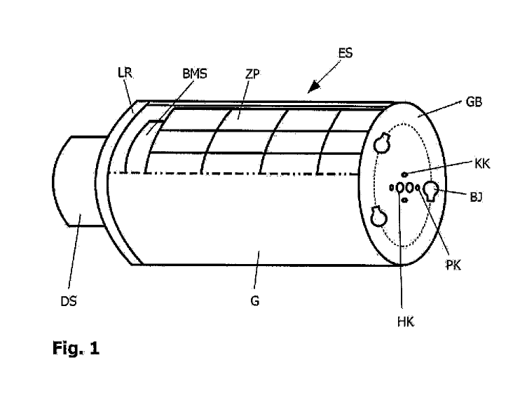

FIG. 1 shows an energy store in a half-sectional illustration, and

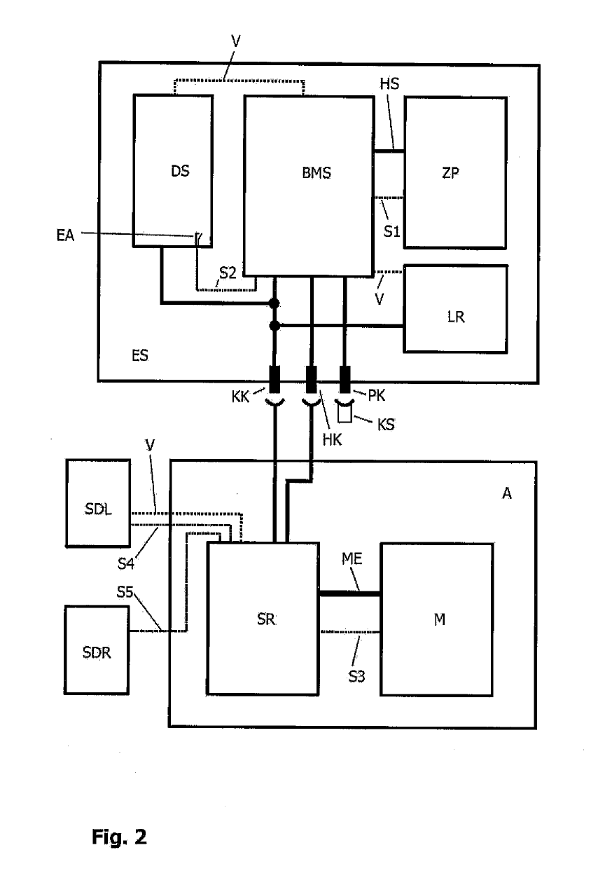

FIG. 2 shows a block circuit diagram of an energy store connected to a mobile consumer.

FIG. 1 shows an energy store ES according to the invention for supplying power to a traction drive, for example an electric bicycle auxiliary drive. A cell unit ZP suitable for this purpose supplies a nominal voltage of preferably 48 V. The cell unit ZP is equipped with a battery management system BMS and arranged together with the latter in a housing G. An indicator device in the form of a luminous ring LR is connected to the housing G, said luminous ring being fed by a light source which is connected to the battery management system BMS in terms of circuitry. The luminous ring LR can be used as indicator device for the selected motor power of the traction drive or the state of charge of the cell unit ZP. The light source is preferably an LED or, in the event of a luminous ring LR which is divided into a plurality of sections, a plurality of LEDs which may be selected to be different colours. The housing G is closed off at its ends by a base plate GB on one side and an input device in the form of a selector switch DS on the other side. The selector switch DS is used to adjust the motor power of the traction drive. The selector switch DS is preferably embodied as a latching rotary switch for three power stages. The selector switch DS additionally has an off switch position or an on/off button. The base plate GB has fastening means BJ to which the energy store is connected using a holding device on the mobile device, that is to say the bicycle. The fastening means BJ are three bayonet sockets arranged on a pitch circle with an asymmetrical angular position with respect to one another, and so the holding device of the mobile device has three bayonet pins arranged at a corresponding angular position and at the same pitch circle diameter. Furthermore, electrical contact means are arranged in the base plate GB. The electrical contact means consist of two high-power contacts HK, two communication contacts KK and two pilot contacts PK. The arrangement of the contact means is illustrated by way of example and may be implemented in any suitable manner. The fastening means BJ can be configured both for individual fastening of the energy store ES and can also be used, in addition to other holding means which one in that case responsible for fastening the energy store ES, exclusively for position definition of the energy store ES with respect to the electrical contact means.

The mode of operation of the energy store ES according to FIG. 1 is explained with reference to the block circuit diagram according to FIG. 2. In addition to the energy store ES according to the invention, the block circuit diagram according to FIG. 2 shows a traction drive A, which energy store and traction drive are connected to one another using the contact means for the high-power connection HK, the communication connection KK and the pilot connection PK. The drive-side pilot connection PK is designed as a short-circuit of the pilot lines, as a result of which the disconnection of the contact means is recognized when the energy store ES is removed. As the pilot contacts PK disconnect earlier than the high-power contacts HK owing to their shorter length compared to said high-power contacts HK, said pilot contacts are switched so as to be voltage-free by the battery management system BMS and a switching arc with contact burning at the high-power contacts HK is avoided. The energy store ES comprises the cell unit ZP, which is connected to the battery management system BMS via two high-power lines HS and a first sensor line S1. The voltage of the individual cells and the temperature of the cell unit are interrogated via the sensor line S1 and the state of charge of the cell unit ZP is determined from this. Furthermore, the input device in the form of the latching rotary switch DS is connected to the battery management system BMS. Said connection is realized firstly by a second sensor line S2 to which the on/off switch EA on the part of the latching rotary switch DS is connected, and secondly, by the two communication lines by virtue of the latching rotary switch DS having an electronic interface in addition to the actuation device in the form of a rotary knob, said electronic interface being used to connect the latching rotary switch DS to the two communication lines. The electronics of the latching rotary switch DS receive the required operating voltage via a supply line V. The indicator device in the form of the luminous ring LR is connected to the battery management system BMS in the same manner, namely by means of the two communication lines and a supply line V. Provided that this makes sense in the context of the invention, the traction drive A consists of a motor M and a control device SR, which are connected to one another by means of phase current lines ME and a third sensor line S3. Furthermore, a torque sensor SDL is connected to the control device SR via a fourth sensor line S4 and a rotational speed sensor SDR is connected to the control device SR via a fifth sensor line S5. The torque sensor SDL is arranged on a standard bottom bracket in the illustrated embodiment of the invention—an energy store ES for a bicycle electric drive—and obtains its operating voltage via the supply line V from the control device SR; the rotational speed sensor SDR may be correspondingly coupled to the rear wheel. A serial bus system, preferably a CAN bus according to ISO 11898, is used as communication connection. Accordingly, the connected units battery management system BMS, latching rotary switch DS, light ring LR on the side of the energy store ES and control device SR on the side of the traction drive A have the standardized prerequisites in terms of circuitry and software which are known to a person skilled in the art and necessary for this purpose. The user selects the support stage using the latching rotary switch DS, which support stage is interpreted by the control device SR as a demand for the power consumption of the motor M, wherein the control device SR obtains actual values from the connected sensors for torque SDL and rotational speed SDR in order to control the parameters, the crankshaft torque and motor rotational speed, selected in the form of the selected support stage. In order to charge the cell unit ZP, the energy store ES can be removed from the holder on the mobile device and positioned in a charging station which corresponds in terms of making contact, which may be designed in a known manner, in particular with respect to its electrical function.

The energy store ES according to the invention is distinguished in that removal and insertion can take place using one hand and the output of the stored energy is controlled by means of an efficient and standardized data transfer. By virtue of the fact that input device, indicator device, battery management system and cell unit are arranged in a housing and the fastening thereof to a mobile consumer is connected with low effort, the energy store according to the invention is additionally suitable for retrofit assembly kits or the like.

### LIST OF REFERENCE SYMBOLS

ES energy store
LR indicator device, luminous ring
BMS battery management system
ZP cell unit
DS input device, rotary switch
G housing
GB housing base
BJ bayonet sockets
HK high-power contacts
KK communication contacts
PK pilot contacts
EA on/off switch
Sn sensor line
V operating voltage line
HS high-power lines
A drive
M mobile consumer, motor
SR control device
SDL torque sensor
SDR rotational speed sensor
ME phase-current lines

1. Energy store for mobile consumers (M), at least comprising a cell unit (ZP) with connected battery management system (BMS), an indicator device (LR) connected to the battery management system (BMS), contact means, connected to the battery management system (BMS), for connecting to contact means of the mobile consumer at least in the form of high-power contacts (HK) and an input device (DS) connected to the battery management system (BMS), wherein the cell unit (ZP) with battery management system (BMS), indicator device (LR), input device (DS) and contact means (HK) are arranged in a housing (G), wherein a plurality of bayonet connections (BJ) are arranged asymmetrically in a housing base (GB) as fastening means for fastening to a mobile device having the consumer (M).

2. Energy store according to claim 1, wherein the indicator device (LR), the input device (DS) and the battery management system (BMS) are connected to a serial bus system.

3. Energy store according to claim 1, wherein the input device (DS) is designed as a selector switch.

4. Energy store according to claim 1, wherein the indicator device (LR) is designed as illumination means.

5. Energy store according to claim 4, wherein the illumination means is designed as a luminous ring.

6. Energy store according to any claim 1, wherein the contact means comprise shorter pilot contacts (PK) in comparison with the high-power contacts (HK).
